(19) United States
(12) Patent Application Publication
(10) Pub. No.: US 2006/0277043 A1
(43) Pub. Date: Dec. 7, 2006

(54) Voice authentication system and methods therefor

(76) Inventors: Edward Tomes, Toronto (CA); Clark Ferguson, Ottawa (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(21) Appl. No.: 11/144,795

(22) Filed: Jun. 6, 2005

(51) Int. Cl. G10L 17/00

(52) U.S. Cl. 704/247

(57) ABSTRACT

The present invention relates to methods and systems for enrolling a user for voice authentication and for performing voice authentication on a user of a network. The method of enrolling a user for voice authentication includes verifying the identity of the user and assigning an enrolment identifier to the user, if the identity of the user is verified. The enrolment identifier is then presented to the user. Subsequently, the user is prompted to utter a personal voice authentication password. The personal password uttered by the user is received and stored. A voice print model for the user is generated from the previously stored voice print. The method further includes storing the voice print model and associating the voice print model and the personal password with the enrolment identifier assigned to the user to facilitate retrieval thereof during voice authentication of the user. A method for performing voice authentication on a user of a network is also provided. The method includes determining whether the user is enrolled for voice authentication based on an available attribute of the logical address of the user on the network. Upon determining that the user is enrolled for voice authentication, a personal password and stored voice print model for the user is retrieved. The stored voice print model includes a voice print of a personal password previously uttered by the user. The method further includes prompting the user to utter the personal password and receiving a spoken response from the user. The spoken response is verified to determine whether it contains the personal password and whether it matches the stored voice print model. If the spoken response contains the personal password and matches the stored voice print model for the user, the identity of the user is authenticated.

### FIELD OF THE INVENTION

The present invention relates to the field of voice authentication. More specifically, the present invention relates to methods and systems for enrolling a user for voice authentication and for performing voice authentication on a user of a network.

### BACKGROUND OF THE INVENTION

With the increasing popularity and availability of Internet-based products and services, customer or user authentication on networks has become a major concern. Often, it is necessary to confirm the identity of the user prior to allowing the user to gain access to certain resources, to consummate a transaction, or complete an online purchase.

In this context, identity verification often requires a user to present to the service provider a set of credentials, in the nature of user ID and password. However, often each service provider implements its own authentication system with its own set of credentials. As a result, it is not unusual for a user to have to remember and present a plurality of such credentials to gain access to different systems or service providers. From a user perspective, this is extremely complex and prone to errors. Moreover, the use of such credentials tends also to pose a security risk in that credentials of that nature may be intercepted and used to perpetrate identity fraud and gain unauthorized access to network resources or services.

From a service provider perspective, the need for user authentication represents significant infrastructure complexity that is expensive to implement and maintain. The service provider is faced with the challenge of enrolling or registering customers for service entitlement and ensuring that the users are clearly and uniquely identified. The enrolment of users for services is often a slow and frustrating process for users and an expensive process for service providers. The process usually requires a face-to-face or live call centre operator interaction with new users and includes a time consuming procedure involving information gathering to confirm the identity of the user. Users are often frustrated that the process varies greatly across different service providers.

Moreover, the service provider must verify the identity of individuals requesting access to a service and confirm both their identity and entitlement. Furthermore, the service provider must properly manage the user credentials and service entitlement and ensure that user privacy is protected in all service transactions and stored databases. These challenges tend to serve as barriers to service providers who wish to introduce new services since the provision of these new services often entails the implementation of a dedicated authentication system.

It is clear from the foregoing that what is required is an approach to identity management that reduces the number of credentials needed for authenticating a user on a plurality of network resources. It would be further desirable if the solution provided enhanced security against identity theft by using credentials that are inherently more difficult to copy, intercept or steal, for instance, biometric credentials.

While the use of biometric credentials, such as fingerprints, retina scans and voice prints, for user authentication is generally known, many of the biometric authentication systems are implemented internally within companies or other institutions and tend not to be configured for versatility or wide spread use in a larger network environment containing various service providers. Moreover, in some of these systems the identity of the user may be pre-authenticated prior to the user providing a sample of its voice to create a reference voice print. Such systems tend to be ill-suited for broader implementations in larger networks.

It would be desirable to have a voice authentication system that could be broadly implemented in networks and that could be commonly used by a plurality of different service providers to verify the identity of users prior to authorizing access to their associated resources. Such a voice authentication system would provide an effective identity management solution, by having built-in flexibility to allow for the relatively easy, enrolment of users while not compromising on security. Moreover, voice verification could be carried out efficiently and cost-effectively in such a system.

### SUMMARY OF THE INVENTION

According to a broad aspect of an embodiment of the invention, there is provided a method of enrolling a user for voice authentication. The method includes: verifying the identity of the user; assigning an enrolment identifier to the user, if the identity of the user is verified; presenting the enrolment identifier to the user; prompting the user to utter a personal voice authentication password; receiving and storing the personal password uttered by the user; generating a voice print model for the user from the personal password uttered by the user; storing the voice print model; and associating the voice print model and the personal password with the enrolment identifier assigned to the user to facilitate retrieval thereof during voice authentication of the user.

In an additional feature, the step of verifying the identity of the user includes performing a first identity verification step based on a first type of identification information. The first identity verification step includes prompting the user to provide a first type of identification information; receiving the first type of identification information provided by the user; retrieving user identification information from a data source based on the first type of identification information received from the user; determining whether the user identification information retrieved from the data sources matches the first type of identification information received from the user; and confirming the identity of the user if the user identification information retrieved from the data sources matches the first type of identification information received from the user. In an additional feature, the step of verifying the identity of the user includes performing a second identity verification step, following confirming the identity of the user, based on a second type of identification information other than the first type of identification information. The second verification step includes: identifying from the user identification information retrieved from the data source the availability of a second type of identification information other than the first type of identification information; retrieving the available second type of identification information; prompting the user for the available second type of identification information; receiving a response from the user; determining whether the response received from the user matches the available second type of identification information; and confirming the identity of the user if the response received from the user matches the available second type of identification information.

In another feature, the step of receiving and storing further includes storing the personal password uttered by the user in the form of a voice print. Moreover, the step of generating includes generating a voice print model for the user from the previously stored voice print. In still an additional feature, the step of receiving and storing further includes: performing voice recognition on the personal password uttered by the user to generate a text string representing the personal password; and storing the text string representing the personal password.

In a further feature, the method of enrolling a user for voice authentication further includes the step of performing voice verification on the user. The step of performing voice verification includes: prompting the user to utter the personal password; receiving a spoken response from the user; verifying whether the spoken response received from the user contains the personal password previously presented to the user; verifying whether the spoken response received from the user matches the stored voice print model of the user; and authenticating the identity of the user if the spoken response received from the user contains the personal password and matches the stored voice print model for the user. Additionally, the step of verifying whether the spoken response received contains the personal password previously presented to the user, includes: performing voice recognition on the spoken response received from the user to generate a first text string; and comparing the first text string to a second string representing the personal password previously presented to the user.

In another broad aspect of an embodiment of the invention, there is provided a method of enrolling a user of a network on a voice authentication system. The method includes: verifying the identity of the user; assigning an enrolment identifier to the user, if the identity of the user is verified; outputting to the user the enrolment identifier; outputting to the user a prompt to elicit from the user an utterance corresponding to a personal password; receiving and storing the utterance; generating a voice print model for the user from the utterance; storing the voice print model; and associating the voice print model and the personal password with the enrolment identifier assigned to the user to facilitate retrieval thereof during voice authentication of the user. In an additional feature, the user has a logical address on the network. Furthermore, the step of assigning includes generating the enrolment identifier from an available attribute of the logical address of the user on the network.

In yet another broad aspect of an embodiment of the invention, there is provided a method of performing voice authentication of a user of a network. The user has a logical address on the network. The method includes: determining whether the user is enrolled for voice authentication based on an available attribute of the logical address of the user on the network; upon determining that the user is enrolled for voice authentication, and retrieving a stored personal password associated with the user and a stored voice print model for the user. The stored voice print model includes a voice print of the personal password previously uttered by the user. The method also includes: prompting the user to utter the personal password; receiving a spoken response from the user; verifying whether the spoken response received from the user contains the personal password associated with the user; verifying whether the spoken response received from the user matches the stored voice print model of the user; and authenticating the identity of the user if the spoken response received from the user contains the personal password associated with the user and matches the stored voice print model for the user.

In an additional feature, the step of determining includes: retrieving the available attribute from the network; and accessing a data source containing a plurality of enrolment identifiers associated with a corresponding plurality of stored voice print models and personal passwords. At least some of the enrolment identifiers have been generated from attributes of the logical addresses of previous users on the network. The step of determining further includes: searching the data source for an enrolment identifier that includes an attribute which matches the available attribute; and determining that the user is enrolled for voice authentication, if an enrolment identifier including an attribute which matches the available attribute, is found on the data source.

In yet a further feature, the step of retrieving a personal password associated with the user and a stored voice print model for the user, includes retrieving the personal password and stored voice print model associated with the enrolment identifier found on the data source.

In yet another feature, the method includes: requesting that a user indicate whether the user is enrolled for voice authentication, if it cannot be determined that the user is enrolled for voice authentication based on the available attribute, requesting including prompting the user to utter an enrolment identifier previously assigned to the user; receiving a spoken response from the user; and determining whether user is enrolled for voice authentication based on the spoken response received from the user. The step of requesting further includes prompting the user to utter a predetermined utterance if the user is not enrolled for voice authentication. The step of determining whether user is enrolled for voice authentication based on the spoken response received from the user, includes: performing speech recognition on the spoken response to generate a first text string; comparing the first text string to a second text string representing the utterance; and determining that the user is not enrolled for voice authentication if the first text string matches the second text string.

In still another feature, the step of verifying whether the spoken response received contains the personal password associated with the user, includes: performing voice recognition on the spoken response received from the user to generate a first text string; and comparing the first text string to a second string representing the personal password associated with the user. The step of verifying whether the spoken response received from the user matches a stored voice print model for the user, includes comparing the spoken response to the stored voice print model.

In a further broad aspect of an embodiment of the invention, there is provided a method of performing voice authentication on a user of a network. The user has a logical address on the network. The method includes enrolling a user for voice authentication and authenticating the identity of the user. The step of enrolling a user for voice authentication includes: verifying the identity of the user; assigning an enrolment identifier to the user, if the identity of the user is verified; outputting to the user the enrolment identifier; outputting to the user a first prompt to elicit from the user a first utterance corresponding to a personal password; receiving and storing the first utterance; generating a voice print model for the user from the first utterance; storing the voice print model; and associating the voice print model and personal password with the enrolment identifier to facilitate retrieval thereof during voice authentication of the user. The step of authenticating the identity of the user includes: determining whether the user is enrolled for voice authentication based on an available attribute of the logical address of the user on the network; upon determining that the user is enrolled for voice authentication, retrieving the stored personal password and voice print model; outputting to the user a second prompt to elicit from the user the personal password; receiving a spoken response from the user; verifying whether the spoken response received from the user contains the stored personal password; verifying whether the spoken response received from the user matches the stored voice print model of the user; and authenticating the identity of the user if the spoken response received from the user contains the stored personal password associated and matches the stored voice print model for the user.

In still another broad aspect of the invention a voice authentication system is provided. The voice authentication system includes: enrolment means for enrolling a user for voice authentication and authentication means for authenticating the identity of the user. The verification means include: verification means for verifying the identity of the user; password assignment means for assigning an enrolment identifier to the user; first output means for outputting the enrolment identifier to the user; and second output means for outputting a first prompt to the user for eliciting a first utterance from the user. The first utterance represents a personal password. The verification means further include: first receiving means for receiving the first utterance; first storage means for storing the first utterance; voice print generation means for generating a voice print model for the user from the first utterance; and second storage means for storing the voice print model. The authentication means include: third output means for outputting a second prompt to the user for eliciting the personal password; second receiving means for receiving a spoken response from the user; means for verifying whether the spoken response received from the user contains the stored personal password; and means for verifying whether the spoken response received from the user matches the stored voice print model of the user.

In another broad aspect of an embodiment of the invention, a voice authentication system is provided. The voice authentication system includes: a processor; an input/output (I/O) device coupled to the processor; and a storage device coupled to the processor. The storage device has sequences of instructions stored therein which can be executed by the processor to cause the voice authentication system to: verify the identity of the user; assign an enrolment identifier to the user, if the identity of the user is verified; output to the user the enrolment identifier; output to the user a first prompt to elicit from the user an utterance corresponding to a personal password; receive and store the utterance; generate a voice print model for the user from the utterance; store the voice print model of the user; and associate the voice print model and personal password with the enrolment identifier assigned to the user to facilitate retrieval thereof during voice authentication of the user. In additional feature, the storage device further has sequences of instructions stored therein which can be executed by the processor to cause the voice authentication system to: output to the user a second prompt to elicit from the user the personal password; receive a spoken response from the user; verify whether the spoken response received from the user contains the personal password; verify whether the spoken response recieved from the user matches the stored voice print model; and authenticate the identity of the user if the spoken response received from the user contains the personal password and matches the stored voice print model for the user.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 illustrates a computer system having a voice authentication application in accordance with an embodiment of the invention, residing thereon;

FIG. 2 is a block diagram showing components of the computer system illustrated in FIG. 1;

FIG. 3 is a simplified block diagram showing the computer system of FIG. 1 in a network environment in accordance with an embodiment of the invention;

FIG. 4 is a block diagram showing the components of the voice authentication application in accordance with an embodiment of the invention;

FIG. 5 is a flowchart illustrating a voice authentication process in accordance with an embodiment of the invention;

FIG. 6 is a flowchart illustrating an enrolment verification process in accordance with an embodiment of the invention;

FIG. 7 is a flowchart illustrating a secondary enrolment verification process in accordance with an embodiment of the invention;

FIG. 8 is a flowchart illustrating an enrolment process in accordance with an embodiment of the invention;

FIG. 9 is a flowchart illustrating a first identity verification process in accordance with an embodiment of the invention;

FIG. 10 is a flowchart illustrating a second identity verification process in accordance with an embodiment of the invention;

FIG. 11 is a flowchart illustrating a process for creating a voice print model for the user; and

FIG. 12 is a flowchart illustrating a process for performing voice verification on the user.

### DETAILED DESCRIPTION OF EMBODIMENTS OF THE INVENTION

The description which follows, and the embodiments described therein are provided by way of illustration of an example, or examples of particular embodiments of principles and aspects of the present invention. These examples are provided for the purposes of explanation and not of limitation, of those principles of the invention. Specific details pertaining to the particular network configuration, architecture, interfaces, procedures and techniques are set forth in order to provide a thorough understanding of the principles and aspects of the invention. However, it will be apparent to those skilled in the art that the principles of the present invention may be put into practice in other embodiments which depart from these specific details. For the purposes of simplicity and clarity, descriptions of well-known devices, hardware, circuits and methods have been omitted so as not to obscure the description of embodiments of the present invention.

A system and methods are described for enrolling a user for voice authentication and for performing voice authentication on a user of a network. It is contemplated that the voice authentication system may be used to provide a common authentication service for a plurality of resources on the network, thereby obviating the need for the provision of a multiplicity of authentication systems.

As will be described in greater detail below, the system carries out an enrolment verification process 86 that entails verifying whether a user is enrolled for voice authentication based on the logical address of the user on the network or based on the user's spoken response. If the system determines that the user is not currently enrolled, the system will initiate an enrolment process 90. Prior to obtaining a reference voice print from the user, the system verifies the identity of the user by carrying two-phased, first and second identity verification process 68 and 70 (collectively, identity verification process 73). The first identity verification process 68 involves obtaining from the user a first type of user identification information and comparing such information to user identification information available from a data source. If the information provided by the user matches the information available from the data source, the identity of the user is initially verified. During the second identity verification process 70, user identification information available from the data source is used to identify the availability of a second type of user identification information for the user. Thereafter, the user is prompted for the second type of user identification information. If the user's response matches with the available second type of user identification information, the identity of the user is established.

Once the identity of the user has been verified, the system will assign, and present to the user, an enrolment identifier. The enrolment identifier may be generated from an attribute of the logical address of the user on the network, or may be selected by the user. The system thereafter will initiate a voice print model creation process 1

that includes prompting the user one or more times to utter a voice authentication password. Each of the user's utterances is stored by the system as a voice print and is used to generate a voice print model or template for the user. The voice print model for the user is then stored by the system for future recall during voice verification or authentication. The enrolment identifier previously assigned to the user is associated with the personal password and the voice print model for the user to facilitate retrieval thereof.

To authenticate the user, the system initiates a password and voice verification process 88 that involves prompting the user to utter the voice authentication password. The system then compares the response received from the user to the stored voice print model of the user. In addition, the system verifies whether the spoken response contains the personal password associated with the user. Upon determining that the user's response matches with the stored voice print model of the user and that the response contains the personal password, the system authenticates the identity of the user. Having been successfully authenticated by the system, the user can be granted access to resources on the network.

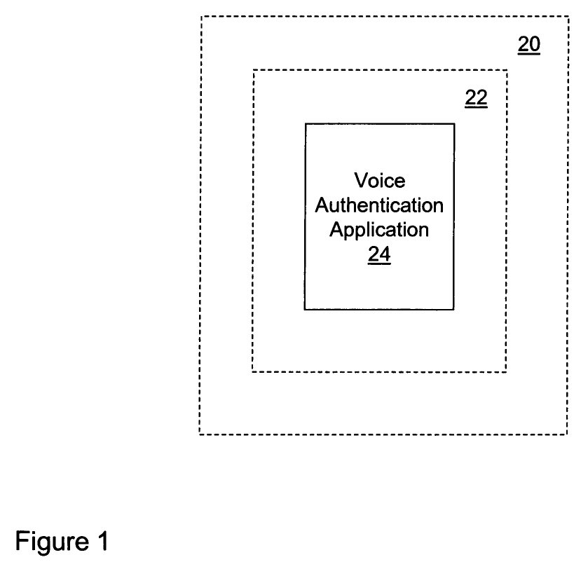

Referring to FIG. 1, there is shown a computer system 20 on which a voice authentication system in accordance with an embodiment of the present invention may be carried out. Computer system 20 includes memory 22 on which may be stored voice authentication application 24. In this particular embodiment, the computer system 20 is a server computer system. The server computer system may be a workstation or a personal computer that runs the Microsoft Windows™ operating system or other similar operating system, as well as other hardware and software.

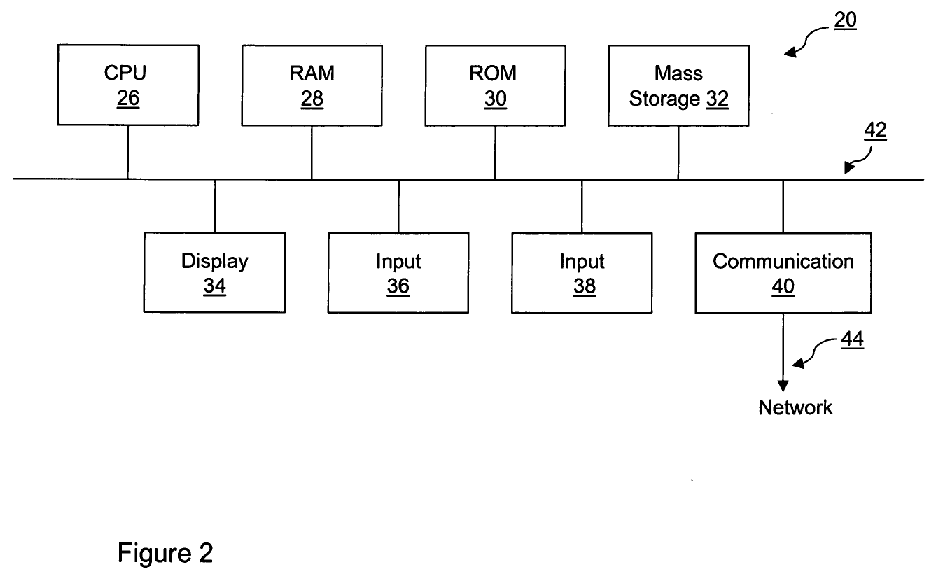

With reference to FIG. 2, computer system 20 includes: a central processing unit (CPU) 26, such as, for example, a microprocessor; random access memory 28 (RAM) for temporary storage of information; read-only memory (ROM) 30 for permanent storage of information; a mass storage device 32; a display device 34; input devices 36 and 38; a communication device 40 and a bus system 42 for connecting the various components of the computer system 20.

Memory 22 in which voice authentication application 24 may be stored and may execute from, may be any of one RAM 28, ROM 30 or mass storage device 32, or any combination thereof. The mass storage device 32 may include any suitable device for storing large volumes of data, such as a magnetic disk or tape, magneto-optical (MO) storage device, or any types of Digital Versatile Disk (DVD) or compact disk (CD-X) storage.

Display device 34 may be any device suitable for displaying alphanumeric, graphical and/or video data, such as a cathode ray tube (CRT), a liquid crystal display (LCD), or the like. The input devices 36 and 38 may include any of various types of input devices, for instance, a keyboard, a mouse, a touchpad, a trackpad or a microphone for speech input.

The communication device 40 may be any device suitable for enabling computer system 20 to communicate voice and data in a network environment over a physical or wireless communication link 44. Examples of such a communication device include a conventional telephone modem, a cable television modem, an Integrated Services Digital Network (ISDN) adapter, a Digital Subscriber Line (xDSL) adapter, a network interface card (NIC), an Ethernet adapter, or the like.

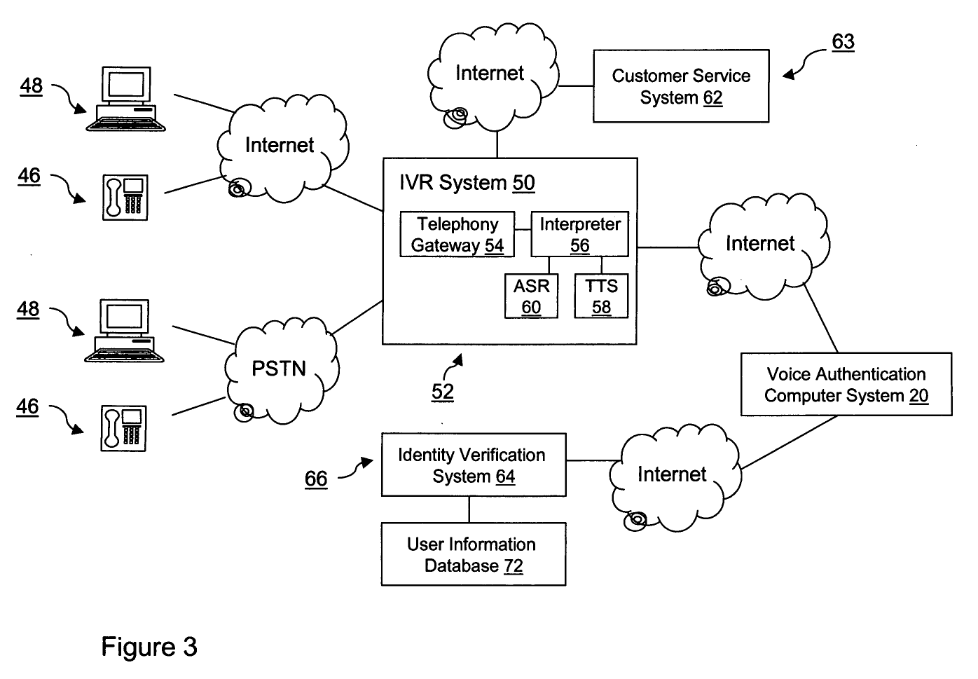

Referring to FIG. 3, there is shown a simplified block diagram illustrating computer system 20 in a network environment in accordance with one embodiment of the invention. The network environment may include a telephone network, a data network, a mobile cellular network, a satellite network, a wired or wireless network, a network capable of supporting internet telephony or VoIP, or any combination of the foregoing. A plurality of telephones 46 and computers 48 is connected to a user interface in the nature of an Interactive Voice Response (IVR) system 50 through a publicly switched telephony network (PSTN) and/or through the Internet. Telephones 46 and computers 48 are representative of the telephones and computers that users may employ to communicate with computer system 20 through IVR system 50. The IVR system 50 resides on a server 52. The server 52 may be a workstation or a personal computer that runs the Linux operating system or other similar operating system, as well as other hardware and software. The IVR system 50 includes a media and call control telephony gateway 54 connected to an interpreter 56. Telephony gateway 54 controls and manages incoming calls received from telephones 46 or computers 48. For instance, telephony gateway 54 can play and record voice messages and reference voice prints, connect call parties, initiate outgoing calls, and receive, process and recognize Dual Tone Multi-Frequency (DTMF) input.

Interpreter 56 communicates via web protocols (HTTP) to computer system 20 and conducts the interaction with the user based on instructions supplied by the voice authentication application 24. In this particular embodiment, the interpreter 56 is a VoiceXML (Voice Extensible Markup Language) interpreter adapted to execute the instructions found in voice authentication application 24, a VoiceXML application.

To enhance its functionality, the interpreter 56 has access to, and may call upon, a text-to-speech (TTS) application 58 for automatically converting text streams to voice, and an automatic speech recognition (ASR) application 60 for identifying spoken words. For example, TTS application 58 could be a product commercially available under the name Speechify® 3.0 and ASR application 60 could be a product commercially available under the name of OpenSpeech™ Recognizer 2.0, both products from ScanSoft Inc. of Boston, Mass., USA. It should however be appreciated that other commercially available, TTS and ASR applications could be employed to similar advantage. In this embodiment, TTS application 58 and ASR application 60 both reside on server 52. This need not be the case in every application. For example, in an alternative embodiment, each application could be made to run on its own dedicated server.

In this embodiment, the IVR system 50 is also connected to a customer service system 62 that resides on a server 63. Customer service system 62 may be any type of system operated by a service provider, for instance, a bank, a financial institution, an insurance company, a utility company, a health care provider, an internet service provider, a security services company, a governmental agency, or the like. Customer service system 62 may provide authorized users with access to certain resources, privileges, services, confidential or personal information, or other data. To avoid identity fraud and misuse of the resources, customer service system 62 requires that the identity of the user be verified by voice authentication before access is granted to the user.

While only a single customer service system is shown in FIG. 3, it should be understood that there may be a plurality of customer service systems connected to the IVR system. In such applications, the IVR system in conjunction with the computer system 20 and identity verification system 64, would define a central authentication infrastructure that would be shared by the various customer service systems. Accordingly, a common authentication system could be used to authenticate the identities of various enrolled users seeking to gain access to a plurality of customer service systems, thereby obviating the need for each customer service system to have its own authentication system and associated infrastructure. In this way, this system tends to leverage advantageously online or network-based identity verification resources.

In an exemplary scenario, a user seeking to access customer service system 62 via telephone 46 or computer 48 is transferred to the IVR system 50. Computer system 20 in cooperation with the identity verification system 64, authenticates the identity of the user prior to the user being granted access to the resources of customer service system 62. If the user is enrolled for voice authentication, voice authentication application 24 will authenticate the identity of the user using password and voice verification process 88. Alternatively, if the user has not yet been enrolled, the identity verification system 64 will perform identity verification procedures to authenticate the user, prior to initiating an enrolment procedure for enrolling the user for voice authentication.

The identity verification system 64 resides on a server 66 that is connected to the computer system 20 through the Internet. In this embodiment, the identity verification system 64 comprises a product commercially available under the name eIDverifier™ from Equifax Inc. of Atlanta, Ga., USA and is generally similar to the identity verification systems described in U.S. Pat. Nos. 6,243,447; 6,282,658; 6,496,936; and 6,321,339 (of which Equifax Inc. is the assignee); the disclosures of which are hereby incorporated by reference. It should however be appreciated that other commercially available or governmental, identity verification systems could be employed to similar advantage. To facilitate understanding of the identity verification system 64 and its interaction with computer system 20, a brief description is provided below.

Broadly speaking, the identity verification system 64 is configured to carry out a first identity verification process 68 based on a first type of identification information (i.e. first name, last name, telephone number, address, or other common personal information) furnished by the user. Such identification information is communicated to the IVR system 50 through telephone 46 or computer 48 and thereafter transmitted to the computer system 20 and ultimately, to the identity verification system 64.

The identity verification system 64 is adapted to initially confirm the identity of the user on the basis of the identification information provided by the user by comparing such identification information with the information stored on a user information database 72. The identity verification system 64 is further configured to perform a second identity verification process 70 based on a second type of identification information (i.e. loan, credit or mortgage information). The availability of the second type of identification information is identified from the user identification information retrieved from the database 72. First and second identity verification processes 68 and 70 are described in greater detail below. While the foregoing description refers to a single database 72, it will be appreciated that the identity verification system 64 may access several databases to perform identity verification processes 68 and 70. Such databases may include a credit database, a phone number database, a mailing address database and other like databases.

It is contemplated that the identity verification system 64 will be used in most cases where the user has not yet registered or enrolled for voice authentication and it is necessary to confirm the identity of the user prior to such enrolment. However, in certain alternative embodiments, it may be desirable to configure the system in such a way that the user's identity is pre-verified, for instance, by the customer service system. In such embodiments, the identity verification system could be bypassed and the first and second identity verification processes could be skipped altogether. In any event, it is understood that once the user is enrolled, all further identity verification or authentication will be performed by the voice authentication system using methods implementing the principles of the present invention.

The network environment described above is exemplary. It will be appreciated that many other configurations are possible. For instance, in an alternative configuration, it may be possible to have the IVR system connected to a virtual private network (VPNe) which serves as a portal to access the computer system, customer service system and identification verification system.

Turning now to voice authentication application 24, in this particular embodiment, application 24 resides and executes from memory 22 on computer system 20 and is a VoiceXML application. While it is generally preferable for security reasons that application 24 run on its own dedicated server computer system (in this case, computer system 20) and serve the function of middleware between the identity verification system 64 and the IVR system 50, this need not be the case in every embodiment. In alternative embodiments, it may be desirable to have the voice authentication application run on the IVR system server. In the further alternative, the application could be made to run on the identity verification system. It will be thus be appreciated that the voice authentication application may be deployed in a plurality of ways and is not intended to be limited to any particular implementation.

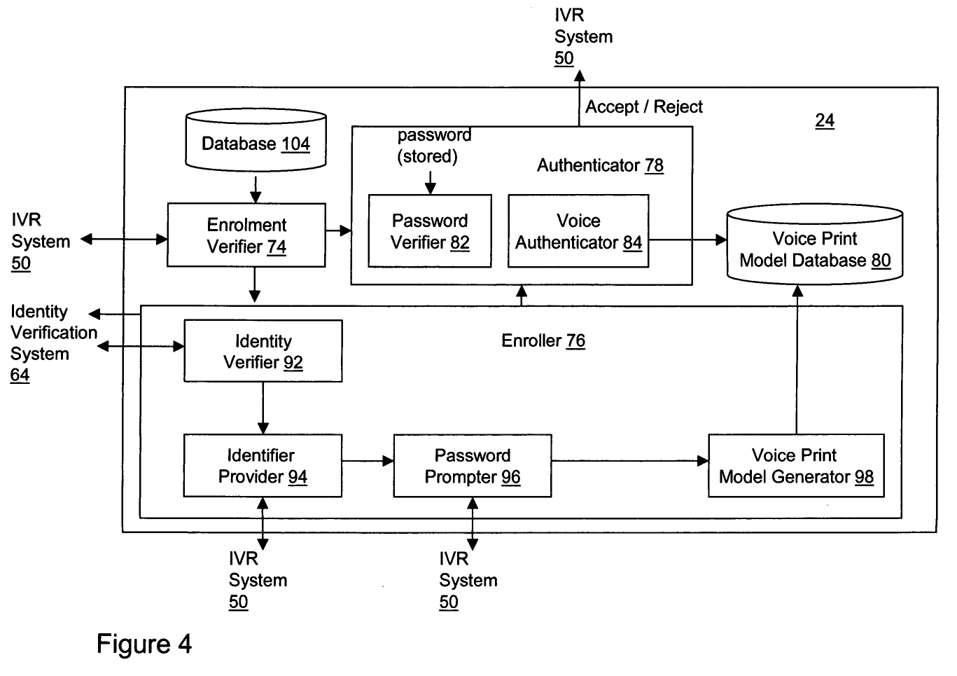

Referring to FIG. 4, there is shown a block diagram illustrating the components of voice authentication application 24 in accordance with an embodiment of the invention. Voice authentication application 24 includes an enrolment verifier 74, an enroller 76, an authenticator 78 and a voice print model database 80. The authenticator 78 is provided with a password verifier 82 and a voice authenticator 84. In one embodiment, the authenticator 78 comprises a product commercially available under the name of SpeechSecure™ from ScanSoft Inc. of Boston, Mass., USA. Of course, in alternative embodiments, other commercially available products could be used to similar advantage.

The enrolment verifier 74 receives input from the user through telephone 46 or computer 48 via the IVR system 52. In response to the input received, the enrolment identifier 74 initiates an enrolment verification process 86 (described in greater detail below). If the enrolment verifier 74 determines that the user is enrolled for voice authentication, it will output to the authenticator 78 the enrollment identifier previously assigned to the user.

Thereafter, authenticator 78 will perform password and voice verification process 88 which includes retrieving from the voice print model database 80 the voice print model or template associated with the user's enrollment identifier and prompting the user to utter the personal password previously assigned to the user. The user's response is relayed to the authenticator 78 through the IVR system 52. The IVR system 52 outputs to the authenticator 78 the user's voice response as well as a text string that represents the user's utterance (the text string having been generated from the user's spoken response by the ASR application 60 residing on server 52).

The password verifier 82 will verify whether the spoken response received from the user contains the personal password previously associated with the user, while the voice authenticator 84 verifies whether the spoken response matches the voice print model for the user. Based on the verifications performed by password verifier 82 and voice authenticator 84, the authenticator 78 will output an “accept” or “reject” signal to IVR system 50. An “accept” signal will be transmitted only if both verifications have been successfully completed. If one or both verifications fail, the authenticator will output a “reject” signal.

If the IVR system 50 receives an accept signal from authenticator 78, it will grant the user access to the resources on the customer service system 62. Conversely, if a “reject” signal is received, the user will be denied access to the resources on the customer service system 62 but may be given the choice to be transferred to an operator for assistance, to exit the system or to try again.

In the event, the enrolment verifier 74 determines that the user is not enrolled for voice authentication, it will output a signal to the enroller 76 which will initiate the one-time, enrolment process 90. Enroller 76 includes a user identity verifier 92, an enrolment identifier provider 94, a password prompter 96 and a voice print model generator 98.

The user identity verifier 92 communicates with the identity verification system 64 with instructions to perform first and second identity verification processes 68 and 70. The first identity verification process 68 is conducted on the basis of input (i.e. a first type of identification information) received from the user through the IVR system 50. Based on the results of the first and second identity verification processes 68 and 70, the identity verification system 64 will output an “accept” or “reject” signal to the user identity verifier 92. If a “reject” signal is outputted by the identity verification system 64, it signifies that the system was unable to verify the identity of the user. At this point, the user identity verifier 92 will present the user with a choice. The user may request to be transferred to an operator for assistance or may exit the system. Conversely, receipt of an “accept” signal is indicative that the identity of the user has been successfully verified.

Upon successful verification of the identity of the user, the identity verifier 92 will output a signal to the enrolment identifier provider 94 which will assign and present to the user an enrolment identifier. The enrolment identifier assigned to the user may be generated from an available attribute of the logical address of the user on the network (i.e. domain name, e-mail address or telephone number). Alternatively, the enrolment identifier can be a numeric, alphanumeric, or solely letter-based identifier selected by the enrolment identifier provider 94. This would be the case, for instance, if the attributes of the logical address of the user on the network were unavailable or if privacy concerns were raised. In a further alternative embodiment, the enrolment identifier could be chosen by the user. In all cases, the enrolment identifier may be stored in the enrolment verifier 74.

In one embodiment, the enrolment identifier is output to the user using TTS application 58. However, it should be appreciated that there may be other ways to present the enrolment identifier to user. For instance, in alternative embodiment, the enrolment identifier could be delivered to the user in a digital certificate. In such an embodiment, subsequent to assigning the enrolment identifier to the user, the provider 94 could be configured to issue to the user an encrypted digital certificate containing the enrolment identifier. During enrolment verification, the user could send an encrypted reply via computer 48 to enrolment verifier 74 containing the enrolment identifier.

Thereafter, the password prompter 96 will initiate a voice print model creation process 100. In the performance of process 100, the password prompter 96 communicates with the user through the IVR system 52 and outputs to the user a prompt eliciting the user to utter a personal password to enable the creation of a reference voice print model. The foregoing step may be repeated several times to obtain multiple voice prints from the user.

For enhanced flexibility and to facilitate easy recall by the user, the personal password may be a password or phrase that the user has selected independently and may be in English or any other language. Moreover, the personal password may be a made-up word or expression. Alternatively, the personal password may be a password corresponding to a cue provided by the password prompter 96. For instance, in one embodiment, the password prompter may set the personal password of the user to correspond to the user's given name and surname. In such a case, the password prompter would cue the user to speak its given name and surname.

The personal password uttered once or multiple times by the user is recorded by the IVR system 50 in the form of one or more voice prints. The recorded voice print(s) is(are) then communicated to the personal password prompter 96 and ultimately, transmitted to the voice print model generator 98. The IVR system 50 also outputs to the password verifier 82 a text string that represents the personal password uttered by the user (the text string having been generated from the user's spoken response by the ASR application 60 residing on server 52). The text string representing the personal password is stored on the password verifier 82 to be accessed when the password and voice verification process 88 is performed.

The voice print model generator 98 will proceed to generate a voice print model or template for the user using generally, well-known techniques. In one embodiment, the generator 98 comprises a product commercially available under the name of SpeechSecure™ from ScanSoft Inc. of Boston, Mass., USA. In alternative embodiments, other products may be used with similar success.

Preferably, the voice print model generator 98 creates a voice print model for the user from several recorded voice prints. In one preferred embodiment, the voice print model for the user is generated from three recorded voice prints corresponding to the user's multiple utterances of its personal password.

In an alternative embodiment, it may be possible to generate a voice print model for the user from multiple different utterances of the user. For instance, with the appropriate modifications, the password prompter may be configured to prompt the user to utter its personal password, its enrolment identifier or any other identifier. Each of the user's utterances could be recorded in the form of a voice print and could be used to generate the voice print model for the user. During authentication, the user could be prompted to state any of the previously uttered passwords or identifiers.

Of course, it will be appreciated that a voice print model for the user may be generated from a single voice print.

Once generated, the user's voice print model is transmitted to the voice print model database 80 where it is stored for future retrieval. In this embodiment, the voice print model database 80 is included as part of the voice authentication application 24 and resides on computer system 20. However, it will be appreciated that this need not be the case in every application. In an alternative embodiment, the voice print model database 80 may reside on its own dedicated server.

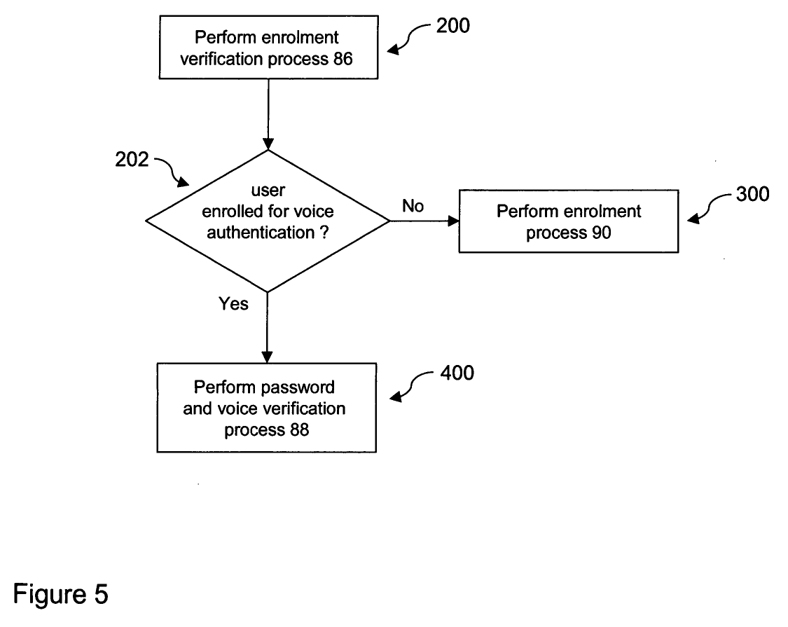

An example of the implementation of the voice authentication system and methods therefor is described below. The IVR system intercepts a user seeking access to the resources on customer service system 62 and transmits signal to voice authentication application 24 to initiate a voice authentication process. With reference to FIG. 5, the enrolment verifier 74 performs enrolment verification process 86 at step 200. If, at step 202, it is determined that the user is enrolled for voice authentication then the authenticator 78 performs password and voice verification process 88 at step 400. Alternatively, if the user is not enrolled, the enroller 76 will carry out the enrolment process 90 at step 300.

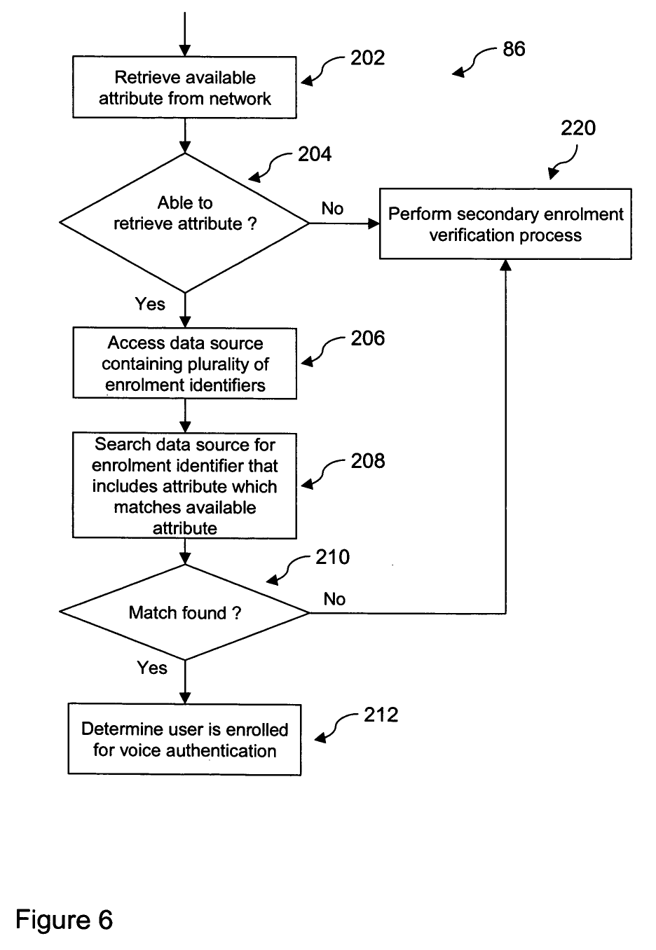

Referring to FIG. 6, there is shown a flowchart illustrating enrolment verification process 86. To determine whether the user is enrolled for voice authentication, the enrolment verifier 74, at step 202, attempts to retrieve an available attribute of the logical address of the user on the network. If an attribute has been retrieved at step 204, the enrolment verifier 74 accesses a data source at step 206. The data source, in the nature of a database 104, contains a plurality of enrolment identifiers stored thereon in a text string format. At least some of these enrolment identifiers have been generated from the attributes of the logical addresses of users of the network. At step 208, the enrolment verifier 74 searches the database 104 for an enrolment identifier that includes an attribute that matches the available attribute of the user's logical address. If such an enrolment identifier is found at step 210, the enrolment verifier 74 determines that the user is enrolled for voice authentication at step 212.

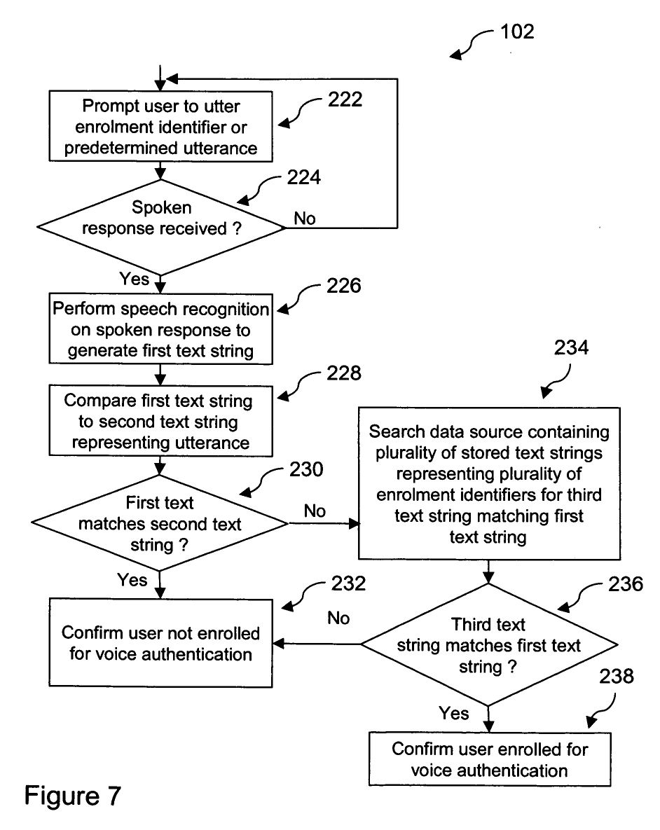

In the event that either an attribute of the user's logical address is unavailable for retrieval or it cannot be matched to an attribute contained with an enrolment identifier stored on the database 104, the enrolment verifier 74 will perform a secondary enrolment verification process 102. With reference to FIG. 7, the enrolment verifier 74 communicating through the IVR system 50, will request that the user indicate whether it is enrolled for voice authentication by prompting the user, at step 222, to utter the previously assigned enrolment identifier or a predetermined utterance. In this case, the predetermined utterance would be indicative that the user is not currently enrolled. For instance, the IVR system 50 could output to the user a message that states the following: “Please state your enrolment identifier if you have already enrolled or just say, I am a new user.”

In the event that no response is received at step 224, step 222 will be repeated again. If the user fails to respond after a predetermined number of prompts, the user will be connected to an operator for assistance or will be made to exit the enrolment identifier 74.

If a spoken response is received at step 224, the enrolment verifier 74 will proceed to determine whether the user is enrolled based on the user's response. At step 226, the ASR application 60 performs speech recognition on the user's response to generate a first text string. At step 228, the first text string is compared to a second text string that represents the predetermined utterance or minor variations thereof. If, at step 230, it is determined that the first text string matches the second text string, then the enrolment verifier 74 confirms that the user is not enrolled for voice authentication at step 232.

However, if the first and second text strings do not match, the enrolment verifier, at step 234, will search database 104 for a text string that matches the first text representing the user's utterance. If, at step 236, a text string matching the first text string is found on database 104, the enrolment verifier will confirm that the user is enrolled for voice authentication. In the event that no matching text string is found, the enrolment verifier 74 will confirm that the user is not currently enrolled.

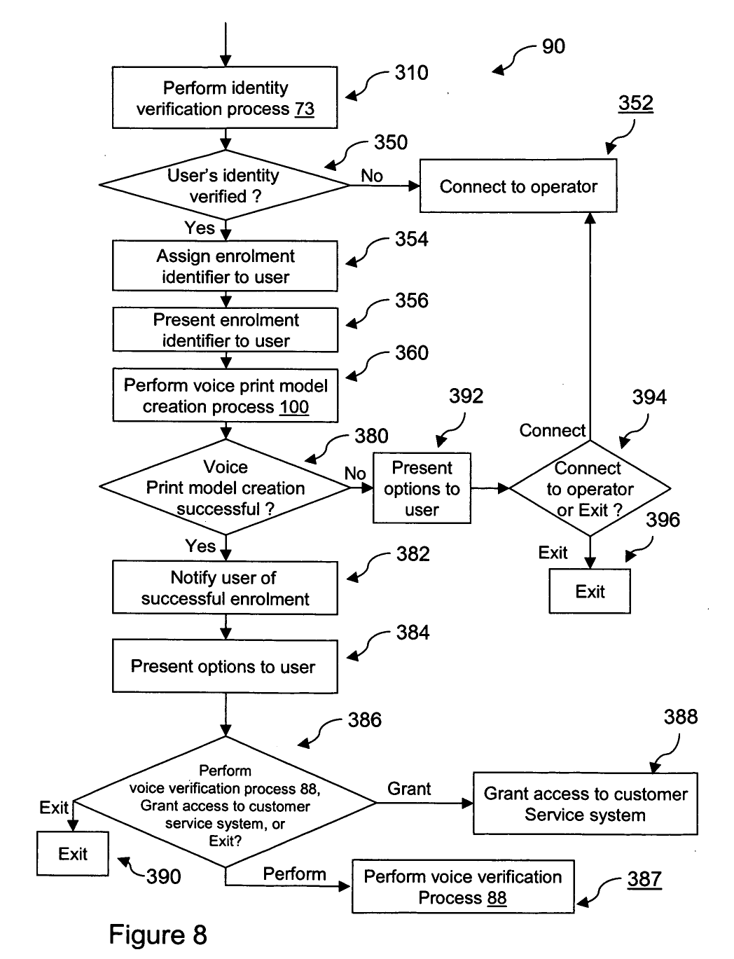

Referring to FIG. 8, there is shown a flowchart illustrating enrolment process 90 carried out by the enroller 76 in conjunction with IVR system 50. More specifically, at step 310, the identity verifier 92 performs identity verification process 73. If the identity of the user cannot be verified at step 350, the IVR system 50 connects the user to an operator for assistance at step 352. However, if the user's identity has been successfully verified, the provider 94 assigns to the user an enrolment identifier at step 354. At step 356, the enrolment identifier is output to the user via the IVR system 50. Thereafter, the password prompter 96 in conjunction with the voice print model generator 98 perform the voice print model creation process 100at step 360. If process 100has been successfully completed at step 380, the enroller 76, at step 382, notifies the user via IVR system 50 that the user has been enrolled for voice authentication. At step 384, the enroller presents the user with several options. Depending on the input received from the user at step 386, one of the following will occur: password and voice verification process 88 will be performed at step 387; the IVR system 50 will, at step 388, grant the user access to the resources of customer service system 62; or the user will exit the IVR system 50 at step 390.

In the event that generator 98 is unable to generate a voice print model for the user, the user will be presented at step 392 with the option to, either be connected to the operator for assistance at step 352 or exit the IVR system 396. The user's input received at step 394 will determine which step is next performed.

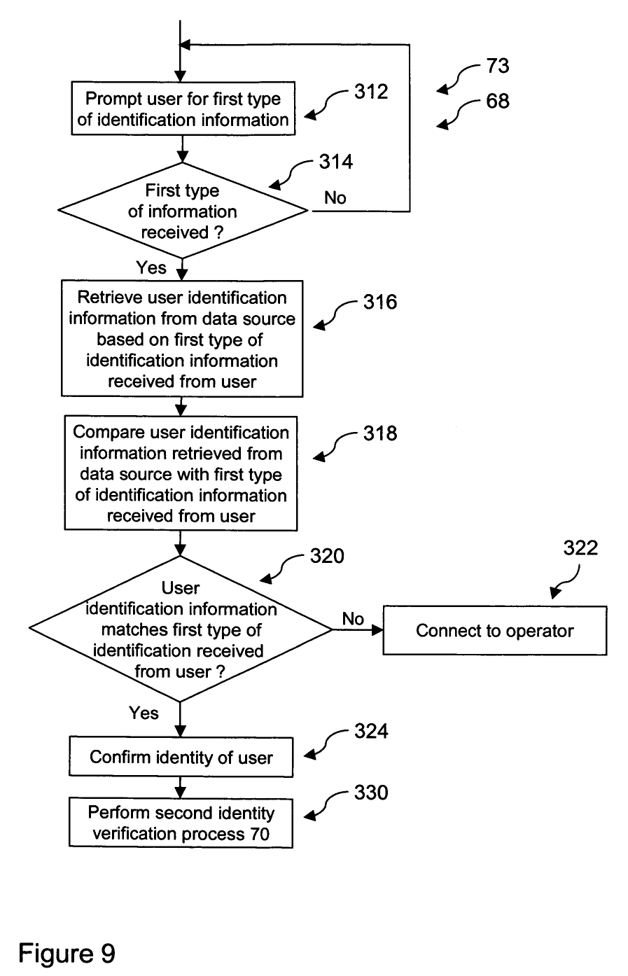

Referring to FIG. 9, there is shown a flowchart illustrating identity verification process 73 performed by identity verifier 92 and identity verification system 64 in conjunction with IVR system 50. At step 312, the user is prompted for a first type of identification information that may include at least one of the following: name information, address (business or home) information, social security number information, gender information, birth date information, telephone number information, e-mail address information, driver's license information, account number information, password information and passport information. Preferably, the user is prompted to provide several pieces of identification information of the first type as to better allows a record containing user identification information, to be located on database 72. The prompt may take the form of a spoken prompt (if the user is communicating by telephone 46, for instance) or alternatively, it may appear as a form on the user's screen to be completed or filled out.

In the event that no response is received at step 314, step 312 will be repeated again. If the user fails to respond after a predetermined number of prompts, the user will be connected to an operator for assistance or will be made to exit the identity verification system 64.

If the first type of information is received from the user at step 314 (either by way of spoken response or the return of a completed form), the identity verification system 64, at step 316, retrieves user identification information from database 72. At step 318, the identity verification system 64 compares the user identification retrieved from database 72 with the first type of information received from the user. If, at step 320, it is determined that the user identification information on the database 72 matches the first type of information received from the user, the identity verification system 64 confirms the identity of the user at step 324 and communicates same to identity verifier 92. Matching user information of the first type to user identification information on the database is accomplished using techniques described in U.S. Pat. Nos. 6,243,447; 6,282,658; 6,496,936; and 6,321,339. If no record matching the first type of information provided by the user is found, the IVR system 50 will connect user to an operator for assistance at step 322.

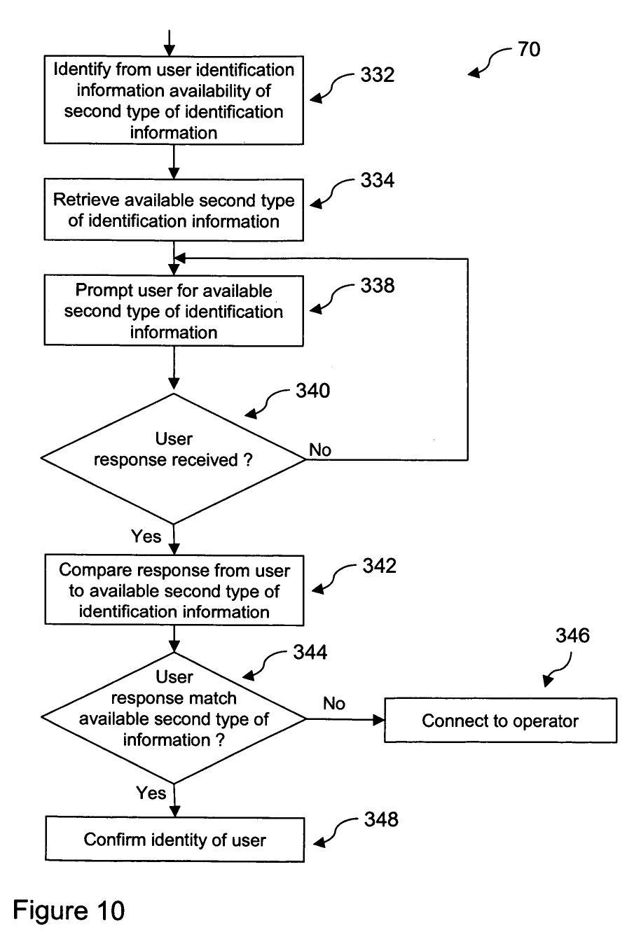

Following successful confirmation of the user's identity based on a first type of identification information, a second identity verification process 70 will be performed at step 330. With reference to FIG. 10, at step 332, the identify verification system 64 identifies the availability of a second type of information in connection with the user, from the user identification information found on the database 72. At step 334, the identify verification system 64 retrieves the available second type of information for the user and generates at least one question based on said information. The answer to this question corresponds to a piece of the second type of information. The second type of information may be any type of information other than the first type of information and may include at least one of the following: financial information, credit information, mortgage information, banking information, health/medical, or other similar personal information. Preferably, a plurality of questions should be generated to query the user. For instance, some or all or all of the following questions may be used: “Do you have a mortgage?”; “What is the amount of your mortgage?”; “With whom is your mortgage?”; “Do you have a car loan?”; “What is the amount of your car loan?” “Do you have any student loans?” At step 338, the user is prompted for the available second type of information. More specifically, the IVR system 50 outputs to user the at least one question to be answered.

In the event that no response is received at step 340, step 338 will be repeated again. If the user fails to respond after a predetermined number of prompts, the user will be connected to an operator for assistance or will be made to exit the identity verification system 64.

If the user's response is received at step 340, the identity verification system 64 verifies whether the user has correctly answered the at least one question by comparing the response received to the available second type of identification information at step 342. If it is determined at step 344 that the user has correctly answered the at least one question, that is, the user's response matches the available second type of information, the identity of the user will be confirmed at step 348. If the user's response does not match the available second type of information, the user will be connected to the operator at step 346.

In this embodiment, to ensure the user's privacy is respected, the identity verifier 92 does not have access to the identification information stored on the identity verification system 64 and database 72. Following the performance of identity verification processes 68 and 70, the identity verification system 64 communicates to the identity verifier 74 a one-time score indicating a match success or failure.

Moreover, in this particular embodiment, the identity verification process 73 includes first and second verification processes 68 and 70. It will be appreciated that in alternative embodiments, it may be sufficient to verify the identity of the user using only a single identity verification process. Alternatively, in some application, it may be desirable to perform additional or different identity verification processes for enhanced protection against identity fraud. Such additional identity verification processes could include one or more biometric identity verification processes.

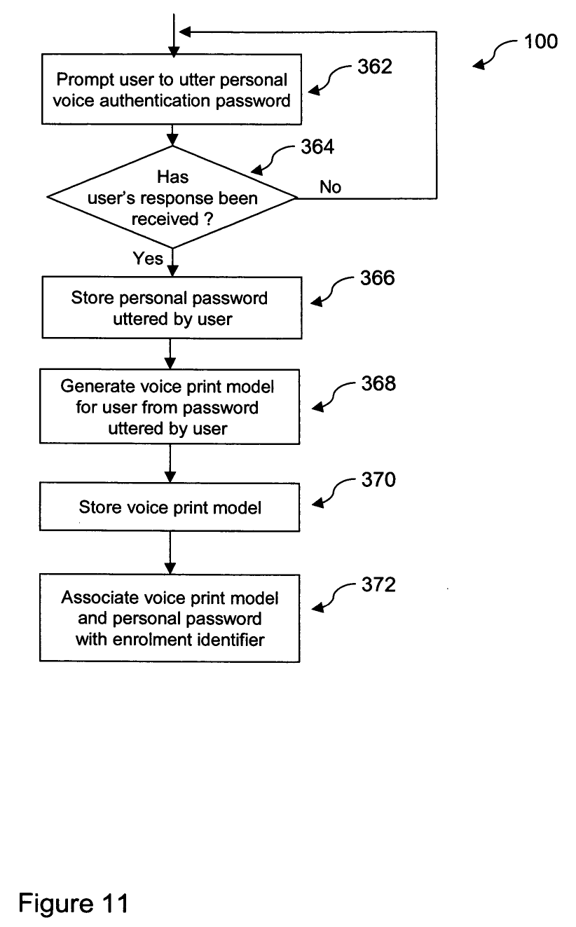

Referring to FIG. 11, there is shown a flowchart illustrating voice print model creation process 100carried out by password prompter 96 and voice print model generator 98, in conjunction with IVR system 50. At step 362, password prompter 96 via IVR system 50 prompts the user to utter a personal password. If the user response has been received at step 364, the IVR system 50 proceeds to record and store the user's utterance at step 366. Using the ASR application 60, the IVR system 50 also performs speech recognition on the user's utterance to generate a text string representing the user's personal password. This text string is outputted to the password verifier 82 where it is stored for future recall during authentication of the user. Steps 362, 364 and 366 may be repeated if the password prompter 96 is configured to prompt the user for multiple utterances to obtain multiple reference voice prints. At step 368, the generator 98 proceeds to generate the voice print model for the user based on one or more of the user's utterances (reference voice prints). At step 370, the voice print model is stored on database 80. At step 372, the user's voice print model and personal password are associated with the user's enrolment identifier.

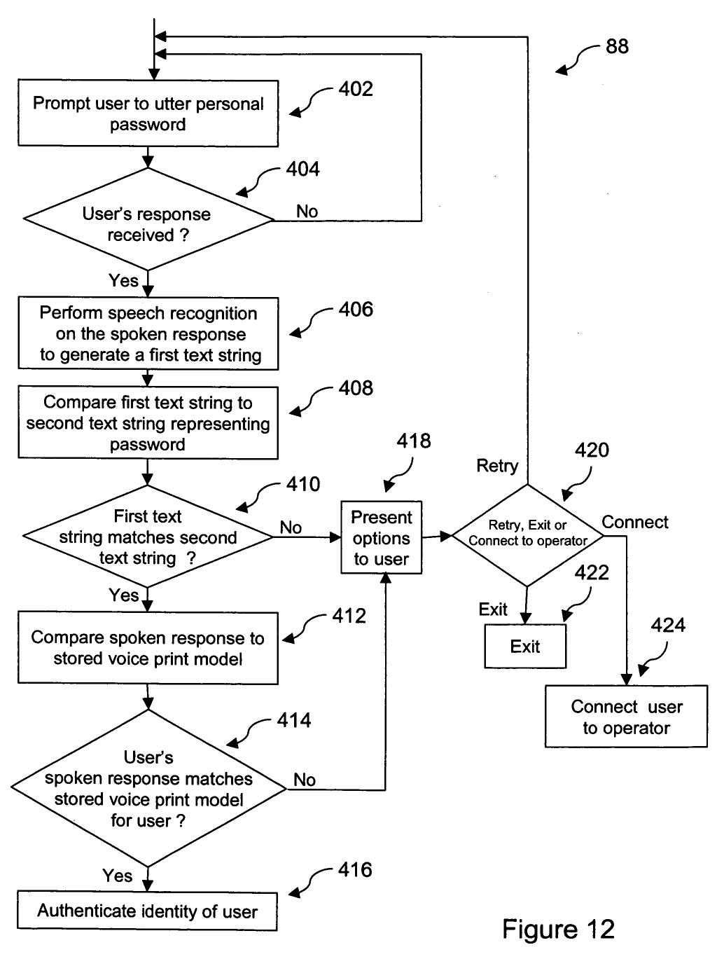

Referring to FIG. 12, there is shown a flowchart illustrating password and voice verification process 88 carried out by authenticator 78 in conjunction with IVR system 50. At step 402, the authenticator 78 prompts the user to utter the personal password previously used during enrolment. If a spoken response is received at step 404, the ASR application 60, at step 406, will perform speech recognition on the spoken response to generate a text string. The password verifier 82 will verify whether the text string representing the spoken response matches the text string representing the personal password of the user by comparing the two text strings. If the text string representing the spoken response matches the personal password of the user at step 410, the voice authenticator 84 will proceed to compare the voice characteristics of the spoken response to those of the stored voice print model at step 412. If it is determined at step 414 that the spoken response matches the stored voice print model, the authenticator 78 will authenticate the identity of the user at step 416 and output an accept signal to the IVR system.

In the event that no response is received at step 404, step 402 will be repeated again. If the user fails to respond after a predetermined number of prompts, the user will be connected to an operator for assistance or will be made to exit the IVR system 50.

If either the text string representing the user's spoken response does not match the text string representing the user's personal password, or the user's spoken response does not match the user's stored voice print model, the user will presented with options at step 418. Depending on the input received from the user at step 420, one of the following will occur: the user will be permitted to retry (that is, attempt the password and voice verification a second time); the user will be made to exit the IVR system 50 at step 422; or the user will be connected to an operator for assistance at step 424.

To prevent abuse of the system and identity theft, the authenticator 78 can be configured to allow only a predetermined of retries following failed attempts to successfully complete the password and voice verification process 100.

From the foregoing disclosure, it will be apparent that the voice authentication system and the methods described above may be computer implemented and may be embodied in software, either in whole or in part. However, it should be appreciated that the principles of the present invention could be implemented to similar advantage by hardwired circuitry used in place of, or in combination with, software instructions. Thus, the present invention is not limited to any specific combination of hardware circuitry and software.

Although the foregoing description and accompanying drawings relate to specific preferred embodiments of the present invention and specific systems and methods relating to enrolment for voice authentication and performance of voice authentication or verification as presently contemplated by the inventors, it will be understood that various changes, modifications and adaptations, may be made without departing from the spirit of the invention.

What is claimed is:

1. A method of enrolling a user for voice authentication, the method comprising:
verifying the identity of the user;
assigning an enrolment identifier to the user, if the identity of the user is verified;
presenting the enrolment identifier to the user;
prompting the user to utter a personal voice authentication password;
receiving and storing the personal password uttered by the user;
generating a voice print model for the user from the personal password uttered by the user;
storing the voice print model; and
associating the voice print model and the personal password with the enrolment identifier assigned to the user to facilitate retrieval thereof during voice authentication of the user.

2. The method of claim 1 wherein verifying the identity of the user includes performing a first identity verification step based on a first type of identification information.

3. The method of claim 2 wherein verifying the identity of the user further includes performing a second identity verification step based on a second type of identification information other than the first type of identification information.

4. The method of claim 2 wherein the first identity verification step includes:
prompting the user to provide a first type of identification information;
receiving the first type of identification information provided by the user;
retrieving user identification information from a data source based on the first type of identification information received from the user;
determining whether the user identification information retrieved from the data sources matches the first type of identification information received from the user; and
confirming the identity of the user if the user identification information retrieved from the data sources matches the first type of identification information received from the user.

5. The method of claim 4 wherein determining whether the user identification information retrieved from the data sources matches the first type of identification information received from the user, includes comparing the user identification information retrieved from the data source with the first type of identification information received from the user.

6. The method of claim 4 wherein the first type of identification information includes at least one of name information, address information, social security number information, gender information, birth date information, telephone number information, e-mail address information, driver's license information, account number information, password information and passport information.

7. The method of claim 6 wherein verifying the identity of the user further includes performing a second identity verification step following confirming the identity of the user.

8. The method of claim 7 wherein performing the second verification step includes:
identifying from the user identification information retrieved from the data source the availability of a second type of identification information other than the first type of identification information;
retrieving the available second type of identification information;
prompting the user for the available second type of identification information;
receiving a response from the user;
determining whether the response received from the user matches the available second type of identification information; and
confirming the identity of the user if the response received from the user matches the available second type of identification information.

9. The method of claim 8 wherein determining whether the response received from the user matches the available second type of identification information, includes comparing the response received from the user to the available second type of identification information.

10. The method of claim 8 wherein the second type of identification information includes at least one of financial information, credit information, mortgage information, banking information and health/medical information.

11. The method of claim 1 wherein the personal password is selected by the user.

12. The method of claim 1 wherein the personal password uttered by the user corresponds to a cue provided to the user.

13. The method of claim 1 further comprising repeating the steps of prompting, receiving and storing the personal password uttered by the user.

14. The method of claim 13 wherein repeating includes repeating the steps of prompting, receiving and storing the personal password uttered by the user, three times.

15. The method of claim 1 further comprising:
prompting the user to utter the enrolment identifier; and
receiving and storing the enrolment identifier uttered by the user.

16. The method of claim 15 wherein generating includes generating a voice print model for the user from the enrolment identifier and the personal password uttered by the user.

17. The method of claim 16 further comprising repeating the steps of prompting, receiving and storing the enrolment identifier uttered by the user.

18. The method of claim 17 wherein repeating includes repeating the steps of prompting, receiving and storing the enrolment identifier uttered by the user, three times.

19. The method of claim 1 wherein receiving and storing further includes storing the personal password uttered by the user in the form of a voice print.

20. The method of claim 19 wherein generating includes generating a voice print model for the user from the previously stored voice print.

21. The method of claim 20 wherein receiving and storing further includes:
performing voice recognition on the personal password uttered by the user to generate a text string representing the personal password; and
storing the text string representing the personal password.

22. The method of claim 21 wherein associating further includes associating the voice print model and the text string representing the personal password with the enrolment identifier assigned to the user.

23. The method of claim 1 further comprising performing voice verification on the user.

24. The method of claim 23 wherein performing voice verification includes:
prompting the user to utter the personal password;
receiving a spoken response from the user;
verifying whether the spoken response received from the user contains the personal password previously presented to the user;
verifying whether the spoken response received from the user matches the stored voice print model of the user;
authenticating the identity of the user if the spoken response received from the user contains the personal password and matches the stored voice print model for the user.

25. The method of claim of claim 23 wherein verifying whether the spoken response received contains the personal password previously presented to the user, includes:
performing voice recognition on the spoken response received from the user to generate a first text string; and
comparing the first text string to a second string representing the personal password previously presented to the user.

26. A method of enrolling a user of a network on a voice authentication system, the method comprising:
verifying the identity of the user;
assigning an enrolment identifier to the user, if the identity of the user is verified;
outputting to the user the enrolment identifier;
outputting to the user a prompt to elicit from the user an utterance corresponding to a personal password;
receiving and storing the utterance;
generating a voice print model for the user from the utterance;
storing the voice print model; and
associating the voice print model and the personal password with the enrolment identifier assigned to the user to facilitate retrieval thereof during voice authentication of the user.

27. The method of claim 26 wherein:
the user has a logical address on the network; and
assigning includes generating the enrolment identifier from an available attribute of the logical address of the user on the network.

28. The method of claim 27 wherein the network is selected from the group consisting of a wired network and a wireless network.

29. The method of claim 28 wherein:
the network includes a telephone network; and
the attribute includes a telephone number.

30. The method of claim 28 wherein the network includes a data network.

31. The method of claim 30 wherein the attribute includes an internet domain name.

32. The method of claim 30 wherein the attribute includes an e-mail address.

33. The method of claim 26 wherein the enrolment identifier is selected by the user.

34. The method of claim 26 wherein the enrolment identifier is provided to the user.

35. The method of claim 26 wherein assigning includes prompting the user to do one of select the enrolment identifier and allow the voice authentication system to generate the enrolment identifier.

36. The method of claim 26 wherein receiving and storing further includes storing the utterance in the form of a voice print.

37. The method of claim 36 wherein generating includes generating a voice print model for the user from the previously stored voice print.

38. The method of claim 37 wherein receiving and storing further includes:
performing voice recognition on the personal password uttered by the user to generate a text string representing the personal password; and
storing the text string representing the personal password.

39. The method of claim 38 wherein associating further includes associating the voice print model and the text string representing the personal password with the enrolment identifier assigned to the user.

40. A method of performing voice authentication of a user of a network, the user having a logical address on the network, the method comprising:
determining whether the user is enrolled for voice authentication based on an available attribute of the logical address of the user on the network;
upon determining that the user is enrolled for voice authentication, retrieving a stored personal password associated with the user and a stored voice print model for the user, the stored voice print model including a voice print of the personal password previously uttered by the user;
prompting the user to utter the personal password;
receiving a spoken response from the user;
verifyng whether the spoken response received from the user contains the personal password associated with the user;
verifying whether the spoken response received from the user matches the stored voice print model of the user; and
authenticating the identity of the user if the spoken response received from the user contains the personal password associated with the user and matches the stored voice print model for the user.

41. The method of claim 40 wherein determining includes:
retrieving the available attribute from the network;
accessing a data source containing a plurality of enrolment identifiers associated with a corresponding plurality of stored voice print models and personal passwords, at least some of the enrolment identifiers having been generated from attributes of the logical addresses of previous users on the network;
searching the data source for an enrolment identifier that includes an attribute which matches the available attribute;
determining that the user is enrolled for voice authentication, if an enrolment identifier including an attribute which matches the available attribute, is found on the data source.

42. The method of claim 41 wherein retrieving a personal password associated with the user and a stored voice print model for the user, includes retrieving the personal password and stored voice print model associated with the enrolment identifier found on the data source.

43. The method of claim 40 further comprising:
requesting that a user indicate whether the user is enrolled for voice authentication, if it cannot be determined that the user is enrolled for voice authentication based on the available attribute, requesting including prompting the user to utter an enrolment identifier previously assigned to the user;
receiving a spoken response from the user; and
determining whether user is enrolled for voice authentication based on the spoken response received from the user.

44. The method of claim 43 wherein requesting further includes prompting the user to utter a predetermined utterance if the user is not enrolled for voice authentication.

45. The method of claim 44 wherein determining whether user is enrolled for voice authentication based on the spoken response received from the user, includes:
performing speech recognition on the spoken response to generate a first text string;
comparing the first text string to a second text string representing the utterance; and
determining that the user is not enrolled for voice authentication if the first text string matches the second text string.

46. The method of claim 45 further including enrolling the user for voice authentication if the first text string matches the second text string.

47. The method of claim 45 wherein enrolling includes:
verifying the identity of the user;
assigning an enrolment identifier to the user, if the identity of the user has been verified;
presenting the enrolment identifier to the user;
prompting the user to utter a personal voice authentication password;
receiving and storing the personal password uttered by the user;
generating a voice print model for the user the personal password uttered by the user;
storing the voice print model; and
associating the voice print model and personal password with the enrolment identifier assigned to the user to facilitate retrieval thereof during voice authentication of the user.

48. The method of claim 45 wherein determining whether the user is enrolled for voice authentication based on the spoken response received from the user, further includes:
searching a data source containing a plurality of stored text strings representing a corresponding plurality of enrolment identifiers, for a third text string that matches the first text string, each enrolment identifier being associated with a corresponding voice print model and personal password; and
determining that the user is enrolled for voice authentication, if the third text string matching the first text string is found on the data source.

49. The method of claim 48 wherein retrieving a personal password associated with the user and a stored voice print model for the user, includes retrieving the stored voice print and personal password associated with the enrolment identifier, represented by the third text string found on the data source.

50. The method of claim of claim 40 wherein verifying whether the spoken response received contains the personal password associated with the user, includes:
performing voice recognition on the spoken response received from the user to generate a first text string; and
comparing the first text string to a second string representing the personal password associated with the user.

51. The method of claim 51 wherein verifying whether the spoken response received from the user matches a stored voice print model for the user, includes comparing the spoken response to the stored voice print model.

52. A method of performing voice authentication on a user of a network, the user having a logical address on the network, the method comprising:
enrolling a user for voice authentication by:
verifying the identity of the user;
assigning an enrolment identifier to the user, if the identity of the user is verified;
outputting to the user the enrolment identifier;
outputting to the user a first prompt to elicit from the user a first utterance corresponding to a personal password;
receiving and storing the first utterance;
generating a voice print model for the user from the first utterance;
storing the voice print model; and
associating the voice print model and personal password with the enrolment identifier to facilitate retrieval thereof during voice authentication of the user; and
authenticating the identity of the user by:
determining whether the user is enrolled for voice authentication based on an available attribute of the logical address of the user on the network;
upon determining that the user is enrolled for voice authentication, retrieving the stored personal password and voice print model;
outputting to the user a second prompt to elicit from the user the personal password;
receiving a spoken response from the user;
verifying whether the spoken response received from the user contains the stored personal password;
verifying whether the spoken response received from the user matches the stored voice print model of the user; and
authenticating the identity of the user if the spoken response received from the user contains the stored personal password associated and matches the stored voice print model for the user.

53. A voice authentication system comprising:
enrolment means for enrolling a user for voice authentication, the enrolment means including:
verification means for verifying the identity of the user;
password assignment means for assigning an enrolment identifier to the user;
first output means for outputting the enrolment identifier to the user;
second output means for outputting a first prompt to the user for eliciting a first utterance from the user, the first utterance representing a personal password;
first receiving means for receiving the first utterance;
first storage means for storing the first utterance;
voice print generation means for generating a voice print model for the user from the first utterance; and
second storage means for storing the voice print model; and
authentication means for authenticating the identity of the user, the authentication means including:
third output means for outputting a second prompt to the user for eliciting the personal password;
second receiving means for receiving a spoken response from the user;
means for verifying whether the spoken response received from the user contains the stored personal password; and
means for verifying whether the spoken response received from the user matches the stored voice print model of the user.

54. A voice authentication system comprising:
a processor;
an input/output (I/O) device coupled to the processor; and
a storage device coupled to the processor and having sequences of instructions stored therein which can be executed by the processor to cause the voice authentication system to:
verify the identity of the user;
assign an enrolment identifier to the user, if the identity of the user is verified;
output to the user the enrolment identifier;
output to the user a first prompt to elicit from the user an utterance corresponding to a personal password;
receive and store the utterance;
generate a voice print model for the user from the utterance;
store the voice print model of the user; and
associate the voice print model and personal password with the enrolment identifier assigned to the user to facilitate retrieval thereof during voice authentication of the user.

55. The voice authentication system of claim 54 wherein the storage device further has sequences of instructions stored therein which can be executed by the processor to cause the voice authentication system to:
output to the user a second prompt to elicit from the user the personal password;
receive a spoken response from the user;
verify whether the spoken response received from the user contains the personal password;
verify whether the spoken response received from the user matches the stored voice print model; and
authenticate the identity of the user if the spoken response received from the user contains the personal password and matches the stored voice print model for the user.
